(19) United States
(12) Patent Application Publication
(10) Pub. No.: US 2004/0234724 A1
(43) Pub. Date: Nov. 25, 2004

(54) Immisible polymer filled optical elements

(75) Inventors: Cheryl J. Kaminsky, Webster, NY (US); Robert P. Bourdelais, Pittsford, NY (US); Michael R. Brickey, Webster, NY (US)

Correspondence Address: Paul A. Leipold, Patent Legal Staff, Eastman Kodak Company, 343 State Street, Rochester, NY, 14650-2201, US

(73) Assignee: Eastman Kodak Company

(21) Appl. No.: 10/443,204

(22) Filed: May 22, 2003

(51) Int. Cl. B32B 1/00; B29D 11/00; B29C 47/88; B29C 55/02

(52) U.S. Cl. 428/141; 428/156; 264/1.34; 264/1.6; 264/210.1; 264/210.2

(57) ABSTRACT

Disclosed is a light directing polymeric film bearing on a surface thereof a three-dimensional features having an Ra of at least 3, the features containing a polymer dispersion comprising a continuous phase thermoplastic first polymeric material and a discontinuous phase thermoplastic second polymeric material that is immiscible with the first polymeric material and is dispersed in elongated micro-regions.

### FIELD OF THE INVENTION

The invention relates to a light directing polymeric film bearing on a surface thereof three dimensional features having an Ra of at least 3 micrometers, the features containing a polymer dispersion comprising a continuous phase first thermoplastic polymeric material and a discontinuous phase second thermoplastic polymeric material that is immiscible with the first polymeric material and is dispersed in elongated micro-regions.

### BACKGROUND OF THE INVENTION

Better control and management of the backlight through use of optical films are driving technological advances for liquid crystal displays (LCD). Optical films are known to the art that are constructed from immiscible polymer blends. These blends can be manipulated to provide a range of reflective and transmissive properties to a film. Immiscible polymer blends have been used to create asymmetric diffusion, reflective polarizers, and other optical elements.

Conventional absorbing (dichroic) polarizers have, as their inclusion phase, inorganic rod-like chains of light-absorbing iodine that are aligned within a polymer matrix. Such a film will tend to absorb light polarized with its electric field vector aligned parallel to the rod-like iodine chains, and to transmit light polarized perpendicular to the rods. Because the iodine chains have two or more dimensions that are small compared to the wavelength of visible light, and because the number of chains per cubic wavelength of light is large, the optical properties of such a film are predominately specular, with very little diffuse transmission through the film or diffuse reflection from the film surfaces. Like most other commercially available polarizers, these polarizing films are based on polarization-selective absorption.

Other films, such as those disclosed in U.S. Pat. No. 4,688,900 (Doane et. al.), include a clear light-transmitting continuous polymer matrix, with droplets of light modulating liquid crystals dispersed within. Stretching of the material reportedly results in a distortion of the liquid crystal droplet from a spherical to an ellipsoidal shape, with the long axis of the ellipsoid parallel to the direction of stretch. U.S. Pat. No. 5,301,041 (Konuma et al.) make a similar disclosure, but achieve the distortion of the liquid crystal droplet through the application of pressure. A. Aphonin, “Optical Properties of Stretched Polymer Dispersed Liquid Crystal Films: Angle-Dependent Polarized Light Scattering, Liguid Crystals, Vol. 19, No. 4, 469-480 (1995), discusses the optical properties of stretched films consisting of liquid crystal droplets disposed within a polymer matrix. He reports that the elongation of the droplets into an ellipsoidal shape, with their long axes parallel to the stretch direction, imparts an oriented birefringence (refractive index difference among the dimensional axes of the droplet) to the droplets, resulting in a relative refractive index mismatch between the discontinuous and continuous phases along certain film axes, and a relative index match along the other film axes. Such liquid crystal droplets are not small as compared to visible wavelengths in the film, and thus the optical properties of such films have a substantial diffuse component to their reflective and transmissive properties. Aphonin suggests the use of these materials as a polarizing diffuser for backlit twisted nematic LCD's. However, optical films employing liquid crystals as the discontinuous phase are substantially limited in the degree of refractive index mismatch between the matrix phase and the discontinuous phase. Furthermore, the birefringence of the liquid crystal component of such films is typically sensitive to temperature.

U.S. Pat. No. 5,268,225 (Isayev) discloses a composite laminate made from thermotropic liquid crystal polymer blends. The blend consists of two liquid crystal polymers which are immiscible with each other. The blends may be cast into a film consisting of a dispersed inclusion phase and a continuous phase. When the film is stretched, the dispersed phase forms a series of fibers whose axes are aligned in the direction of stretch. While the film is described as having improved mechanical properties, no mention is made of the optical properties of the film. However, due to their liquid crystal nature, films of this type would suffer from the infirmities of other liquid crystal materials discussed above.

Other optical films have been made by incorporating a dispersion of inclusions of a first polymer into a second polymer, and then stretching the resulting composite in one or two directions. U.S. Pat. No. 4,871,784 (Otonari et al.) is one example of this technology. The polymers are selected such that there is low adhesion between the dispersed phase and the surrounding matrix polymer, so that an elliptical void is formed around each inclusion when the film is stretched. Such voids have dimensions of the order of visible wavelengths. The refractive index mismatch between the void and the polymer in these “microvoided” films is typically quite large (about 0.5), causing substantial diffuse reflection. However, the optical properties of microvoided materials are difficult to control because of variations of the geometry of the interfaces, and it is not possible to produce a film axis for which refractive indices are relatively matched, as would be useful for polarization-sensitive optical properties. Furthermore, the voids in such material can be easily collapsed through exposure to heat and pressure.

There thus remains a need in the art for methods of manufacturing diffusely reflective articles from an optical body including a continuous and a discontinuous phase, wherein the refractive index mismatch between the two phases along the material's three dimensional axes can be conveniently and permanently manipulated to achieve desirable degrees of diffuse and specular reflection and transmission, wherein the optical material is stable with respect to stress, strain, temperature differences, and electric and magnetic fields, and wherein the optical material has an insignificant level of iridescence. Furthermore, it is desirable to have optical elements in the form of surface features filled with a diffusely reflective material.

U.S. Pat. No. 6,256,146 (Merrill et al.) discloses post forming a continuous/discontinuous phase (immiscible polymer blend) reflective polarizer. The continuous/discontinuous phase reflective polarizer is first formed and then in a second operation is further stretch or vacuum molded.

Post-forming, as discussed with respect to the present invention, involves further processing or shaping of the optical bodies to obtain some permanent deformation in the optical body. In general, post-forming can involve a texturing of the optical body, shallow drawing of the optical body, and deep drawing of the optical body.

Because the optical bodies used in connection with the present invention may rely on birefringent materials that provide strain-induced refractive index differentials to obtain the desired optical properties, variations in deformation of the optical bodies during post-forming can be particularly problematic to optical performance.

The post forming vacuum forming creates large features (typically greater than 2.5 centimeters), it would be desirable for the film to have micro-replicated features that have additional optical utility. Furthermore, it is difficult to emboss an oriented immiscible polymer blend after orientation (post-forming process) in that it requires much more heat and pressure to emboss than an unstretched cast or extruded sheet and may cause unwanted optical effects such as changing the birefringence of one or more of the phases. It would be desirable to create surface features in the immiscible polymer blend at the same time as the immiscible polymer film is created so that the surface features contain the immiscible polymer blend and the birefringence of the phases remains essentially the same.

US patent application 2001/0011779 (Stover) discloses a mutlilayer reflective polarizer with a textured surface. This surface is impressed as the mutlilayer reflective polarizer is formed. The texture created reduces wet-out of the film and moiré patterns. This texture would be under 3 micrometers in surface roughness and would therefore not have a significant optical effect to the light passing through the reflective polarizer. Furthermore, the surface texture imparted would only affect the outermost layer of the multilayered film and therefore not impact the optical properties of the multilayered polarizer. It would be desirable to have surface features on the multilayered film that had optical utility and that effected the under laying layers in the film for an optical effect.

U.S. Pat. No. 6,111,696 (Allen et al.) discloses a combination of a reflective polarizer with a brightness enhancement film with prisms. The combination can be of the two separate films used together in display or the brightness enhancement prisms can be applied directed to the reflective polarizer in a separate operation. While this combination provides an efficient brightness enhancement film/reflective polarizer, it would be desirable to form the brightness enhancement film/reflective polarizer in one manufacturing step and to have the immiscible polymer reflective polarizing material in the brightness enhancement film surface features. Furthermore, because the brightness enhancement films are coated onto the reflective polarizer, the mismatch of indices of refraction between the brightness enhancement features and the reflective polarizer would cause a loss in the efficiency of the film.

### PROBLEM TO BE SOLVED BY THE INVENTION

There remains a need for an article and process that provides improved light management of the backlight of a backlit polarized display including polarization and collimation.

### SUMMARY OF THE INVENTION

The invention provides a light directing polymeric film bearing on a surface thereof three dimensional features having an Ra of at least 3 micrometers, comprising a continuous phase first thermoplastic polymeric material and a second thermoplastic polymeric material that is immiscible with the first polymeric material and is dispersed in elongated micro-regions.

### ADVANTAGEOUS EFFECT OF THE INVENTION

The invention provides an article and process that provides improved collimated, polarized light for a backlight display system.

### BRIEF DESCRIPTION OF THE DRAWINGS

FIG. 1 illustrates a cross section of an embodiment of the invention where the three dimensional features are a linear array of pyramidal structures, where the linear array is parallel to the discontinuous phase orientation.

FIG. 2 illustrates a cross section of an embodiment of the invention where the three dimensional features are a linear array of pyramidal structures, where the linear array is perpendicular to the discontinuous phase orientation.

FIG. 3 illustrates a cross section of an embodiment of the invention where the three dimensional features are random individual optical elements.

### DETAILED DESCRIPTION OF THE INVENTION

The invention has numerous advantages over prior practices in the art.

The reflective polarizer with surface features can be created in one processing step, saving time and money. If the film was to be embossed after stretching, much more heat and pressure would be need to emboss the pattern because the film was already strain hardened, and so much heat and pressure would have to be used that it might effect the optical properties of the film by changing the immiscible polymer blend or changing the birefringence of the film.

It is also beneficial to have the immiscible polymer blend substantially only in the surface features because less material is used and the light is both polarized and shaped at the same time rather than sequentially.

Furthermore, there is not change in index of refraction between the surface features and the immiscible polar blend so there is no loss of efficiency in the film due to index of refraction mismatch. These and other advantages will be apparent from the detailed description below.

Many optical films useful in connection with the present invention and methods of manufacturing them are described in U.S. patent application Ser. Nos. 08/610,092; 08/609,753; 08/610,109; 08/610,110 (all filed on Feb. 29, 1996); Ser. No. 08/801,329 (filed Feb. 18, 1997); Ser. Nos. 08/807,262; 08/807,268; 08/807,270; 08/807,930 (all filed on Feb. 28, 1997); and Ser. No. 09/006,455 (filed Jan. 13, 1998); as well as in U.S. Pat. No. 5,751,388 (Larson) and various other patents, patent applications, articles, and other documents referred to herein.

“Three dimensional features” are surface features that have a height, width, and length. The term “light shaping element” means any structure that directs light as it passes through or reflects off of it. For example, a prism structure that collimates light or metallic lenses that directs or reflects light out in a random or specific direction are light shaping elements. The light directing can be at the micro or macro level. “Three dimensional features” are any feature on a surface that has width in three dimensions. “Elongated”, in reference to the discontinuous phase, means that the phase is elongated in at least one direction. “Micro-regions” are the elongated regions that the discontinuous phase forms in the continuous phase when the film is oriented or stretched and exhibit at least one dimension in the range of 1-1000 micrometers. The discontinuous phases are formed and oriented by the extrusion process and then when stretched become micro-regions. The term “roughness average” or “Ra” means the average peak to valley dimension for the optical features.

The term “LCD” means any rear projection display device that utilizes liquid crystals to form the image. The term “diffuser” means any material that is able to diffuse specular light (light with a primary direction) to a diffuse light (light with random light direction). The term “diffuse light transmission” means the percent diffusely transmitted light at 500 nm as compared to the total amount of light at 500 nm of the light source. The term “total light transmission” means percentage light transmitted through the sample at 500 nm as compared to the total amount of light at 500 nm of the light source. This includes both spectral and diffuse transmission of light. “Diffuse reflection” is the % of light reflected diffusely (meaning that the incident and angle and reflected angle differ by more than 2.5 degrees). “Total reflection” is the total amount of light reflected by the sample. “Diffuse reflection efficiency is the diffuse reflection divided by the total reflection multiplied by 100.

The term “polymeric film” means a film comprising polymers. The term “polymer” means homo- and co-polymers. The term “average”, with respect to lens size and frequency, means the arithmetic mean over the entire film surface area. The term “pattern” means any predetermined arrangement of lenses whether regular or random.

The term “light” means visible light. “Transparent” means a film with total light transmission of 70% or greater at 500 nm. “Height/diameter ratio” and “aspect ratio” means the ratio of the height of the complex lens to the diameter of the complex lens. “Diameter” means the largest dimension of the surface feature in the x and y plane.

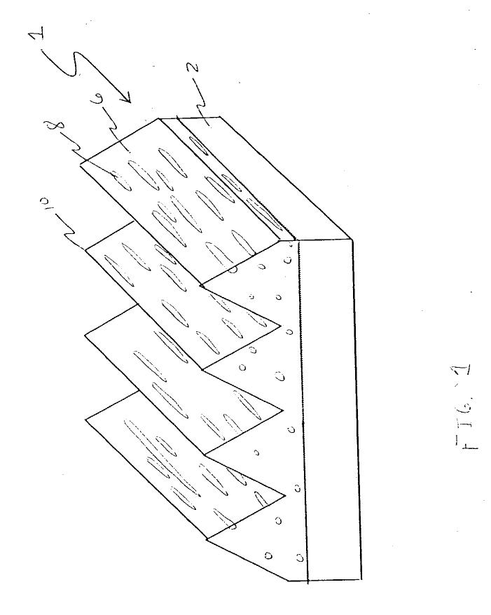

FIG. 1 illustrates a cross section of an embodiment of the invention where the three dimensional features are a linear array of pyramidal structures, where the linear array is parallel to the discontinuous phase orientation 1. The continuous phase first thermoplastic polymeric material 6 and discontinuous phase thermoplastic polymeric material 8 in the linear array of prisms 10 is on substrate 2. The discontinuous phase thermoplastic polymeric material 8 in this embodiment forms cylindrical discontinuities that are parallel to the linear array of prisms 10.

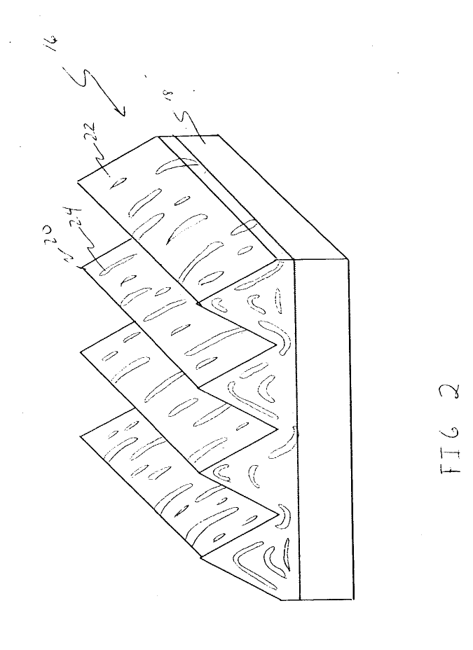

FIG. 2 illustrates a cross section of an embodiment of the invention where the three dimensional features are a linear array of pyramidal structures, where the linear array is perpendicular to the discontinuous phase orientation 16. The continuous phase first thermoplastic polymeric material 22 and discontinuous phase thermoplastic polymeric material 24 in the linear array of prisms 20 is on substrate 18. The discontinuous phase thermoplastic polymeric material 8 in this embodiment forms cylindrical discontinuities that are perpendicular to the linear array of prisms 10.

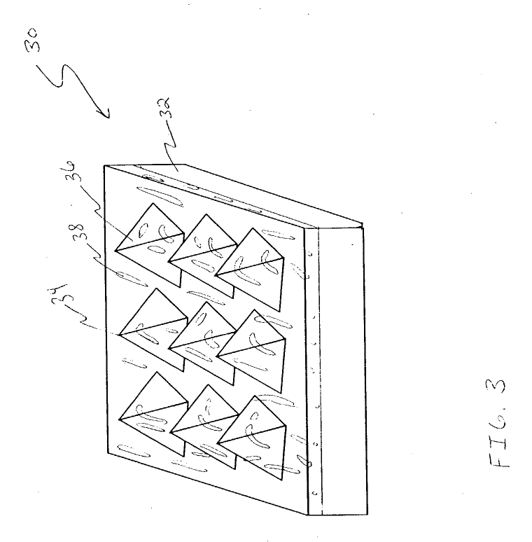

FIG. 3 illustrates a cross section of an embodiment of the invention where the three dimensional features are individual optical elements 34. The continuous phase first thermoplastic polymeric material 36 and discontinuous phase thermoplastic polymeric material 38 in the individual optical elements 34 is on substrate 32. The optical properties of the films in FIGS. 1, 2 and 3 would each be different.

While the index mismatch is the predominant factor relied upon to promote scattering and the reflective polarizing nature of in the film of the present invention, the geometry of the particles of the discontinuous phase can have a secondary effect on scattering. Thus, the depolarization factors of the particles for the electric field in the index of refraction match and mismatch directions can reduce or enhance the amount of scattering in a given direction. For example, when the discontinuous phase is elliptical in a cross-section taken along a plane perpendicular to the axis of orientation, the elliptical cross-sectional shape of the discontinuous phase contributes to the asymmetric diffusion in both back scattered light and forward scattered light. The effect can either add or detract from the amount of scattering from the index mismatch.

The shape of the discontinuous phase particles can also influence the degree of diffusion of light scattered from the particles. This shape effect is generally small but increases as the aspect ratio of the geometrical cross-section of the particle in the plane perpendicular to the direction of incidence of the light increases and as the discontinuous phases get relatively larger. In general, in the operation of this invention, the discontinuous phase should be sized less than several wavelengths of light in one or two mutually orthogonal dimensions if diffuse, rather than specular, reflection is preferred.

Preferably, for a low loss reflective polarizer, the preferred embodiment consists of a discontinuous phase disposed within the continuous phase as a series of rod-like structures which, as a consequence of orientation, have a high aspect ratio which can enhance reflection for polarizations parallel to the orientation direction by increasing the scattering strength and dispersion for that polarization relative to polarizations perpendicular to the orientation direction. However, the discontinuous phase may be provided with many different geometries. Thus, the discontinuous phase may be disk-shaped or elongated disk-shaped, rod-shaped, or spherical. Other embodiments are contemplated wherein the discontinuous phase has cross sections which are approximately elliptical (including circular), polygonal, irregular, or a combination of one or more of these shapes. The cross-sectional shape and size of the particles of the discontinuous phase may also vary from one discontinuous region to another, or from one region of the film to another (i.e., from the surface to the core). These alternate geometries are preferred based on the reflective polarization and diffuse versus specular reflection desired.

The geometry of the discontinuous phase may be arrived at through suitable orientation or processing of the optical material, through the use of discontinuous phases having a particular geometry, or through a combination of the two. Thus, for example, a discontinuous phase having a substantially rod-like structure can be produced by orienting a film consisting of approximately spherical discontinuous phases along a single axis. The rod-like structures can be given an elliptical cross-section by orienting the film in a second direction perpendicular to the first. As a further example, a discontinuous phase having a substantially rod-like structure in which the rods are rectangular in cross-section can be produced by orienting in a single direction a film having a discontinuous phase consisting of a series of essentially rectangular flakes.

Stretching is one convenient manner for arriving at a desired geometry, since stretching can also be used to induce a difference in indices of refraction within the material. As indicated above, the orientation of films in accordance with the invention may be in more than one direction, and may be sequential or simultaneous.

In another example, the components of the continuous and discontinuous phases may be extruded such that the discontinuous phase is rod-like in one axis in the unoriented film. Rods with a high aspect ratio may be generated by orienting in the direction of the major axis of the rods in the extruded film. Plate-like structures may be generated by orienting in an orthogonal direction to the major axis of the rods in the extruded film.

Dimensional alignment is also found to have an effect on the scattering behavior of the discontinuous phase. In particular, it has been observed in optical bodies made in accordance with the present invention that aligned scatterers will not scatter light symmetrically about the directions of specular transmission or reflection as randomly aligned scatterers would. In particular, inclusions that have been elongated through orientation to resemble rods scatter light primarily along (or near) the surface of a cone centered on the orientation direction and along the specularly transmitted direction. This may result in an anisotropic distribution of scattered light about the specular reflection and specular transmission directions. For example, for light incident on such an elongated rod in a direction perpendicular to the orientation direction, the scattered light appears as a band of light in the plane perpendicular to the orientation direction with an intensity that decreases with increasing angle away from the specular directions. By tailoring the geometry of the inclusions, some control over the distribution of scattered light can be achieved both in the transmissive hemisphere and in the reflective hemisphere.

Preferably, the immiscible polymer blend is substantially only in the surface features because less material is used and the light is both polarized and shaped at the same time rather than sequentially. “Substantially”, when discussing the blend location, means approximately 80% of the volume of the blend is in the surface features. It has been shown that the more the discontinuous phases conform to the geometry of the surface features, the more efficient the light shaping of the film is.

The light directing film is typically manufacturing using extrusion and stretching. The two or more phases of the light directing film are mixed and feed into an extruder where they are melted and mixed. The film may be co-extruded with a substrate that may or may not be a blend of polymers to increase the strength of the film during extrusion and stretching. The molten mixture is then extruded through a die (typically a slit die) into a nip between two rollers. The extruding process aligns the micro-regions of the discountinuous thermoplastic polymer with respect to the flow of the polymers. This extrusion can be either vertical or horizontal extrusion. At least one roller has three-dimensional patterns in them to form surface features on the film. Preferably, at least one of the rollers has a pattern in it so that when the molten polymer flows between the two rollers, it flows into the pattern, is cooled below its melting temperature, and pulled out of the roller. This creates a web that has the inverse of the pattern on the roller. As the polymers are flowing and being pressed into the pattern of the roller, the micro-regions conform to the three dimensional geometry of the pattern. The web is then heated and stretched in the machine direction and/or the transverse direction at the same time or sequentially. The film may be stretched constrained or unconstrained. It has been shown that stretching the film unconstrained produces more efficient reflective polarizers than those stretched constrained. As the film is being stretched the surface features are stretched as well, so the stretching ratio and extent must be calculated into the pattern that is on the roller(s). For an optimized reflective polarizer/luminance enhancing collimating film, one would have to design the desired resultant surface features and back calculate what the starting surface feature geometry would be.

It is preferable to first form the film with a pattern and then stretch it, to first stretching and orienting the film and then embossing. Embossing an already stretched and oriented film requires more heat and pressure making the process slow, and energy intensive and must heat the web to a temperature where changes in the polymeric film might occur. For example, if an already stretched and oriented PEN with PMMA immiscible polymer film was to be emboss, the heat used might change the crystal structure and the geometry of the discontinuous phase and thus change the optical properties of the film. Furthermore, embossing is an extra manufacturing step, whereas creating the surface features when extruding does not significantly change the manufacturing flow.

Preferably, the discontinuous regions conform to the geometry of the three dimensional features. When the discontinuous regions conform to the surface features, additional optical benefits can be gained. Instead of having the discontinuous regions lie in one plane, they can lie in two or three planes shaping and reflecting the light differently. Examples of the surface features filled with the immiscible polymer blend are found as FIGS. 1 and 2. This may more efficiently transmit the correct polarization of light and reflect the other at high angles because of the curved discontinuous phases. Preferably the discontinuous regions fulfill the following equation.

$$\vert \frac{ⅆ z}{ⅆ x} \vert or \vert \frac{ⅆ z}{ⅆ y} \vert > 0$$

This equation defines how the discontinuous phases change in the z direction with respect to the x and y directions. When the discontinuous regions follow the above equation, the film more efficiently transmits the correct polarization of light and reflect the other at high angles because of the curved nature of the discontinuous phases. This means that light coming in at high angles to the normal, such as 80 degrees would in a typical reflective polarizer with immiscible polymers, would not be as efficiently processed as light coming in at angles closer to the normal. With the discontinuous phases following the surface features, the light coming into the film at high angles would be more efficiently processed because the light would pas through some curved discontinuous phases at an angle closer to the normal of the curved discontinuous phase.

In applications where the optical body is to be used as a low loss reflective polarizer, the structures of the discontinuous phase preferably have a high aspect ratio, i.e., the structures are substantially larger in one dimension than in any other dimension. The aspect ratio is preferably at least 2, and more preferably at least 5, and most preferred at least 100. The largest dimension (i.e., the length) is preferably at least 2 times the wavelength of the electromagnetic radiation over the wavelength range of interest, and more preferably at least 4 times the desired wavelength. On the other hand, the smaller (i.e., cross-sectional) dimensions of the structures of the discontinuous phase are preferably less than or equal to the wavelength of interest, and more preferably less than 0.5 times the wavelength of interest.

The size of the discontinuous phase also can have a significant effect on scattering. If the discontinuous phase particles are too small (i.e., less than about 1/30th of the wavelength of light in the medium of interest) and if there are many particles per cubic wavelength, the optical body behaves as a medium with an effective index of refraction somewhat between the indices of the two phases along any given axis. In such a case, very little light is scattered. If the particles are too large, the light is specularly reflected from the surface of the particle, with very little diffusion into other directions. When the particles are too large in at least two orthogonal directions, undesirable iridescence effects can also occur. Practical limits may also be reached when particles become large in that the thickness of the optical body becomes greater and desirable mechanical properties are compromised.

The dimensions of the particles of the discontinuous phase after alignment can vary depending on the desired use of the optical material. Thus, for example, the dimensions of the particles may vary depending on the wavelength of electromagnetic radiation that is of interest in a particular application, with different dimensions required for reflecting or transmitting visible, ultraviolet, infrared, and microwave radiation. Generally, however, a characteristic dimension of the particles should be such that they are approximately greater than the wavelength of electromagnetic radiation of interest in the medium, divided by 30.

Preferably, in applications where the optical body is to be used as a low loss reflective polarizer, the discontinuous phases will have a characteristic dimension that is greater than about 2 times the wavelength of the electromagnetic radiation over the wavelength range of interest, and preferably over 4 times the wavelength. The average diameter of the particles is preferably equal or less than the wavelength of the electromagnetic radiation over the wavelength range of interest, and preferably less than 0.5 of the desired wavelength. While the dimensions of the discontinuous phase are a secondary consideration in most applications, they become of greater importance in thin film applications, where there is comparatively little diffuse reflection.

The optical bodies used in connection with the present invention may include more than two phases. Thus, for example, an optical body used in connection with the present invention can include two or more different discontinuous phases within the continuous phase. The additional discontinuous phases could be randomly or non-randomly dispersed throughout the continuous phase, and/or they may be randomly aligned or aligned along a common axis.

Optical bodies used in connection with the present invention may also include more than one continuous phase. Thus, in some embodiments, the optical body may include, in addition to a first continuous phase and a discontinuous phase, a second phase that is co-continuous in at least one dimension with the first continuous phase. In one particular embodiment, the second continuous phase is a porous, sponge-like material that is coextensive with the first continuous phase (i.e., the first continuous phase extends through a network of channels or spaces extending through the second continuous phase, much as water extends through a network of channels in a wet sponge). In a related embodiment, the second continuous phase is in the form of a dendritic structure that is coextensive in at least one dimension with the first continuous phase. Having more than two phases is preferred because added optical and processing benefits.

The volume fraction of the discontinuous phase also affects the scattering of light in the optical bodies of the present invention. Within certain limits, increasing the volume fraction of the discontinuous phase tends to increase the amount of scattering that a light ray experiences after entering the body for both the match and mismatch directions of polarized light. This factor is important for controlling the reflection and transmission properties for a given application.

The desired volume fraction of the discontinuous phase will depend on many factors, including the specific choice of materials for the continuous and discontinuous phases. However, the volume fraction of the discontinuous phase will typically be at least about 1% by volume relative to the continuous phase, more preferably within the range of about 5 to about 15%, and most preferably within the range of about 15 to about 30%. This range has been shown to produce the most efficient reflective polarizers. Preferably, the volume fraction of the discontinuous phase in the continuous phase varies across the film. This can change the efficiency of the reflective polarizer. This variation can be tailored to the backlight to create a more even output of light for a liquid crystal (or any oter backlit polarized light) display.

The indices of refraction of the continuous and discontinuous phases are preferably substantially matched (i.e., differ by less than about 0.05) along a first of three mutually orthogonal axes, and are substantially mismatched (i.e., differ by more than about 0.05) along a second of three mutually orthogonal axes. Preferably, the indices of refraction of the continuous and discontinuous phases differ by less than about 0.03 in the match direction, more preferably, less than about 0.02, and most preferably, less than about 0.01. The indices of refraction of the continuous and discontinuous phases preferably differ in the mismatch direction by at least about 0.05, more preferably at least about 0.07, even more preferably by at least about 0.1, and most preferably by at least about 0.2.

The mismatch in refractive indices along a particular axis has the effect that incident light polarized along that axis will be substantially scattered, resulting in a significant amount of reflection. By contrast, incident light polarized along an axis in which the refractive indices are matched will be spectrally transmitted or reflected with a much lesser degree of scattering. This effect can be utilized to make a variety of optical devices, including reflective polarizers and mirrors.

In one preferred embodiment, the materials of at least one of the continuous and discontinuous phases are of a type that undergoes a change in refractive index upon orientation. Consequently, as the body is oriented in one or more directions during manufacturing, refractive index matches or mismatches are produced along one or more axes. By careful manipulation of orientation parameters and other processing conditions, the positive or negative birefringence of the matrix can be used to induce diffuse reflection or transmission of one or both polarizations of light along a given axis. The relative ratio between transmission and diffuse reflection is dependent on the concentration of the discontinuous phase inclusions, the thickness of the body, the square of the difference in the index of refraction between the continuous and discontinuous phases, the size and geometry of the discontinuous phase inclusions, and the wavelength or wavelength band of the incident radiation.

The magnitude of the index match or mismatch along a particular axis directly affects the degree of scattering of light polarized along that axis. In general, scattering power varies as the square of the index mismatch. Thus, the larger the index mismatch along a particular axis, the stronger the scattering of light polarized along that axis. Conversely, when the mismatch along a particular axis is small, light polarized along that axis is scattered to a lesser extent and is thereby substantially transmitted specularly through the volume of the body.

If the index of refraction of the inclusions (i.e., the discontinuous phase) matches that of the continuous host media along some axis, then incident light polarized with electric fields parallel to this axis will be substantially specularly transmitted (unscattered) through the optical body, regardless of the size, shape, and density of inclusions. If the indices are not matched along some axis, then the inclusions will scatter light polarized along this axis. For scatterers of a given cross-sectional area with dimensions larger than approximately λ/30 (where λ is the wavelength of light in the media), the strength of the scattering is largely determined by the index mismatch. The exact size, shape and alignment of a mismatched inclusion play a role in determining how much light will be scattered into various directions from that inclusion.

When the material is to be used as a polarizer, it is preferably processed, as by stretching and allowing some dimensional relaxation in the cross stretch in-plane direction, so that the index of refraction difference between the continuous and discontinuous phases is large along a first axis in a plane parallel to a surface of the material and small along the other two orthogonal axes. This results in a large optical anisotropy for electromagnetic radiation of different polarizations.

The materials selected for use in an optical body designed to function as a reflective polarizer in accordance with the present invention, and the degree of orientation of these materials, are preferably chosen so that the phases in the finished optical body have at least one axis for which the associated indices of refraction are substantially equal. The match of refractive indices associated with that axis results in substantially no reflection of light in that plane of polarization.

The discontinuous phase may also exhibit a change in the refractive index associated with the direction of orientation after stretching. It is preferred that the discontinuous phase exhibit a decrease in the refractive index after stretching. If the birefringence of the host is positive, a negative strain induced birefringence of the discontinuous phase has the advantage of increasing the difference between indices of refraction of the adjoining phases associated with the orientation axis while the reflection of light with its plane of polarization perpendicular to the orientation direction is still negligible. For an optically polarizing body, differences between the indices of refraction of adjoining phases in the direction orthogonal to the orientation direction should be less than about 0.05 after orientation, and preferably, less than about 0.02, and more preferably, less than about 0.01.

The discontinuous phase may also exhibit a positive strain induced birefringence. However, this can be altered by means of heat treatment to match the refractive index of the axis perpendicular to the orientation direction of the continuous phase. The temperature of the heat treatment should not be so high as to relax the birefringence in the continuous phase.

It should be understood that the continuous phase might exhibit a negative strain induced birefringence. For this case, it is preferred that the discontinuous phase exhibits an increase in the refractive index after stretching.

It is preferred that the film has a gain of at least 1.2 when illumined by a backlight in an LCD display. Gain is defined as the light output at the normal to the display with the light directing polymeric film divided by the light output at the normal to the display without the light directing polymeric film. Having a gain of at least 1.2 creates a display that can be brighter or that can use less battery power. More preferred is a gain of 1.5.

Preferably, the three-dimensional features are substantially void-free. Polymers can be chosen for the reflective polarizer that there is low adhesion between the discontinuousd phase and the surrounding matrix polymer, so that an elliptical void is formed around each inclusion when the film is stretched. Such voids have dimensions of the order of visible wavelengths that cause scattering and loss in efficiency of the reflective polarizer. Furthermore, the optical properties of microvoided materials are difficult to control because of variations of the geometry of the interfaces, and the voids in such material can be easily collapsed through exposure to heat and pressure.

The light directing polymeric film preferably comprises voided structures (but preferably not in the three-dimensional features). The voided structure can be throughout the entire film, but is preferably in a skin layer to give the diffusion qualities to the film to create a diffuse reflective polarizer. Voided structures are less susceptible to scratches, which can affect operating performance. Also, because the voids are typically filled with air, the light management film has more of a white appearance and can even out the color temperature of the backlight system. Furthermore, voided structures are easily changed during manufacturing to have different degrees of diffusion and transmission to be adapted to each display system.

Microvoids of air in a polymer matrix are preferred and have been shown to be a very efficient diffuser of light. The microvoided layers containing air have a large index of refraction difference between the air contained in the voids (n=1) and the polymer matrix (n=1.2 to 1.8). This large index of refraction difference provides excellent diffusion and high light transmission.

An index of refraction difference between the air void and the thermoplastic matrix is preferably greater than 0.2. An index of refraction difference greater than 0.2 has been shown to provide excellent diffusion and high contrast in the projected printed projection media as well as allowing the diffusion to take place in a thin film. The diffusion elements preferably contains at least 4 index of refraction changes greater than 0.2 in the vertical direction. Greater than 4 index of refraction changes have been shown to provide enough diffusion for an overhead projection application. 30 or more index of refraction differences in the vertical direction, while providing excellent diffusion, significantly reduces the amount of transmitted light.

Microvoided composite oriented sheets are conveniently manufactured by coextrusion of the core and surface layers, followed by biaxial orientation, whereby voids are formed around void-initiating material contained in the core layer. Such composite sheets are disclosed in, for example, U.S. Pat. Nos. 4,377,616; 4,758,462; and 4,632,869.

“Nanocomposite” shall mean a composite material wherein at least one component comprises an inorganic phase, such as a smectite clay, with at least one dimension in the 0.1 to 100 nanometer range. “Plates” shall mean particles with two dimensions of the same size scale and is significantly greater than the third dimension. Here, length and width of the particle are of comparable size but orders of magnitude greater than the thickness of the particle.

“Layered material” shall mean an inorganic material such as a smectite clay that is in the form of a plurality of adjacent bound layers. “Platelets” shall mean individual layers of the layered material. “Intercalation” shall mean the insertion of one or more foreign molecules or parts of foreign molecules between platelets of the layered material, usually detected by X-ray diffraction technique, as illustrated in U.S. Pat. No. 5,891,611 (line 10, col.5-line 23, col. 7).

“Intercalant” shall mean the aforesaid foreign molecule inserted between platelets of the aforesaid layered material. “Exfoliation” or “delamination” shall mean separation of individual platelets in to a disordered structure without any stacking order. “Intercalated” shall refer to layered material that has at least partially undergone intercalation and/or exfoliation. “Organoclay” shall mean clay material modified by organic molecules.

The light directing polymeric film of the invention preferably has particulate layered materials with an aspect ratio between 10:1 and 1000:1. The aspect ratio of the layered material, defined as the ratio between the lateral dimension (i.e., length or width) and the thickness of the particle, is an important factor in the amount of light diffusion. An aspect ratio much less than 8:1 does not provide enough light diffusion. An aspect ratio much greater than 1000:1 is difficult to process. Having layered particles or particulates in the film adds diffusion to the reflective polarizer.

The layered materials are preferably present in an amount between 1 and 10% by weight of the binder. Layered materials present in an amount less than 0.9% by weight of the binder have been shown to provide very low levels of light diffusion. Layered materials in an amount over 11% have been shown to provide little increase in light diffusion while adding unwanted color to the binder, coloring transmitted light. Layered materials that are present in an amount between 1.5% and 5% by weight of the binder are most preferred as the visible light diffusion is high while avoiding unwanted coloration and additional expense of additional materials. Further, layered materials present in the amount from 1.5% to 5% have been shown to provide excellent light diffusion for specular backlight assemblies such as those found in liquid crystal displays.

The three dimensional features are preferably dimensionally modified by at least 5% using heat. The three dimensional features can also be altered using a combination of heat and pressure or just pressure. The process consists of using heat and/or pressure in a gradient or pattern to alter the shape of the three dimensional features. This is preferably done before the light directing film is stretched because once stretched and the film is oriented, the amount of heat and/or pressure required to alter the surface features is much greater and can change the optical properties of the polymeric film. When heat and/or pressure is applied to the feature partially or fully melts, flows, and cools to form a new structure where some or all of the feature is flattened. Heat and/or pressure is a way to selectively turn parts diffuse reflective areas into partially diffuse or specular areas of reflection/transmission of the image device and can be applied in a very precise way to create dots, lines, patterns, and text in the light directing film. This can be employed to tailor the amount of diffuse and specular transmission and reflection across a reflective polarizer film to tailor it to the backlight output.

Preferably, a resistive thermal head or laser thermal system applies the heat and/or pressure. The resistive thermal head, such as a print head found in a thermal printer, uses heat and pressure to melt the three dimensional surface features. This process is preferred because it has accurate resolution, can add color at the same time as melting the surface features, and uses heats and pressures to melt a range of polymers. Preferably, color is added to the areas of specular reflection. The color added is preferably a dye because dyes are transparent so the colored areas show up bright and colored. Furthermore, dyes are easily added at the same time the specular areas are created using dyes that sublimate and a thermal printer. This is advantaged because there are no registration issues between the areas of color (with dye) and the areas of modifies surface features because they are created at the same time using a printing technique that is inexpensive and already supported by the printing industry.

Preferably, the three dimensional features are on both sides of the light directing polymeric film. By having surface features on more than one side, more light shaping can be accomplished because the light will pass through two interfaces with surface features. For example, the surface facing the light source may have a diffuser texture such as a complex lens structure on it to diffuse the light and the side away from the light source might have features that serve to collimate the light such as prismatic arrays or pyramidal shapes. In one embodiment, the three dimensional features on both sides are aligned. The surface features structures on either side can vary, for example, in curvature, depth, size, spacing, and geometry, and aspect ratio.

If the height difference from the surface of the plane of the light shaping elements is less than 2 micrometers than the light shaping elements cannot shape light as effectively. Preferably, the average height is greater than 5 micrometers. It has been shown that when the surface features are on average 5 micrometers or taller, the light shaping elements are able to shape light very efficiently. Furthermore, the immiscible polymers are going to be forced into the surface features and the discontinuous polymer will form particles that bend in more than two directions to give added optical and reflective polarizer advantages. If the surface features were less than 2 micrometers, not much of the immiscible polymer blend would be dislocated. Most preferred, the average height is greater than 15 micrometers. A surface feature with a height of over 15 micrometers can shape the light efficiently. If the film before stretching has a small roughness average (Ra), when stretched the roughness average becomes even smaller and reduces the light shaping characteristics of the film. When stretched, the film's Ra tends to decrease.

The three dimensional features preferably have an average aspect ratio of 0.1 to 7.0. When the aspect ratio of the three dimensional features are less than 0.07, the amount of curvature or slope is too low to sufficiently shape the light in transmission or reflection. When the aspect ratio of the diffusion elements is greater than 9.2, it becomes difficult produce these using extrusion roll molding techniques.

Many different materials may be used as the continuous or discontinuous phases in the optical bodies of the present invention, depending on the specific application to which the optical body is directed. Such materials include inorganic materials such as silica-based polymers, organic materials such as liquid crystals, and polymeric materials, including monomers, copolymers, grafted polymers, and mixtures or blends thereof. The exact choice of materials for a given application will be driven by the desired match and mismatch obtainable in the refractive indices of the continuous and discontinuous phases along a particular axis, as well as the desired physical properties in the resulting product. However, the materials of the continuous phase will generally be characterized by being substantially transparent in the region of the spectrum desired.

A further consideration in the choice of materials is that the resulting product must contain at least two distinct phases. This may be accomplished by casting the optical material from two or more materials that are immiscible with each other. Alternatively, if it is desired to make an optical material with a first and second material which are not immiscible with each other, and if the first material has a higher melting point than the second material, in some cases it may be possible to embed particles of appropriate dimensions of the first material within a molten matrix of the second material at a temperature below the melting point of the first material. The resulting mixture can then be cast into a film, with or without subsequent orientation, to produce an optical device.

Suitable polymeric materials for use as the continuous or discontinuous phase in the present invention may be amorphous, semicrystalline, or crystalline polymeric materials, including materials made from monomers based on carboxylic acids such as isophthalic, azelaic, adipic, sebacic, dibenzoic, terephthalic, 2,7-naphthalene dicarboxylic, 2,6-naphthalene dicarboxylic, cyclohexanedicarboxylic, and bibenzoic acids (including 4,4′-bibenzoic acid), or materials made from the corresponding esters of the aforementioned acids (i.e., dimethylterephthalate). Of these, 2,6-polyethylene naphthalate (PEN) is especially preferred because of its strain induced birefringence, and because of its ability to remain permanently birefringent after stretching. PEN has a refractive index for polarized incident light of 550 nm wavelength which increases after stretching when the plane of polarization is parallel to the axis of stretch from about 1.64 to as high as about 1.9, while the refractive index decreases for light polarized perpendicular to the axis of stretch. PEN exhibits a birefringence (in this case, the difference between the index of refraction along the stretch direction and the index perpendicular to the stretch direction) of 0.25 to 0.40 in the visible spectrum. The birefringence can be increased by increasing the molecular orientation. PEN may be substantially heat stable from about 155° C. up to about 230° C., depending upon the processing conditions utilized during the manufacture of the film.

Polybutylene naphthalate is also a suitable material as well as other crystalline naphthalene dicarboxylic polyesters. The crystalline naphthalene dicarboxylic polyesters exhibit a difference in refractive indices associated with different in-plane axes of at least 0.05 and preferably above 0.20.

When PEN is used as one phase in the optical material of the present invention, the other phase is preferably polymethylmethacrylate (PMMA) or a syndiotactic vinyl aromatic polymer such as polystyrene (sPS). Other preferred polymers for use with PEN are based on terephthalic, isophthalic, sebacic, azelaic or cyclohexanedicarboxylic acid or the related alkyl esters of these materials. Naphthalene dicarboxylic acid may also be employed in minor amounts to improve adhesion between the phases. The diol component may be ethylene glycol or a related diol. Preferably, the index of refraction of the selected polymer is less than about 1.65, and more preferably, less than about 1.55, although a similar result may be obtainable by using a polymer having a higher index of refraction if the same index difference is achieved.

Syndiotactic-vinyl aromatic polymers useful in the current invention include poly(styrene), poly(alkyl styrene), poly(styrene halide), poly(alkyl styrene), poly(vinyl ester benzoate), and these hydrogenated polymers and mixtures, or copolymers containing these structural units. Examples of poly(alkyl styrenes) include: poly(methyl styrene), poly(ethyl styrene), poly(propyl styrene), poly(butyl styrene), poly(phenyl styrene), poly(vinyl naphthalene), poly(vinylstyrene), and poly(acenaphthalene) may be mentioned. As for the poly(styrene halides), examples include: poly(chlorostyrene), poly(bromostyrene), and poly(fluorostyrene). Examples of poly(alkoxy styrene) include: poly(methoxy styrene), and poly(ethoxy styrene). Among these examples, as particularly preferable styrene group polymers, are: polystyrene, poly(p-methyl styrene), poly(m-methyl styrene), poly(p-tertiary butyl styrene), poly(p-chlorostyrene), poly(m-chloro styrene), poly(p-fluoro styrene), and copolymers of styrene and p-methyl styrene may be mentioned.

Furthermore, as co-monomers of syndiotactic vinyl-aromatic group copolymers, besides monomers of above explained styrene group polymer, olefin monomers such as ethylene, propylene, butene, hexene, or octene; diene monomers such as butadiene, isoprene; polar vinyl monomers such as cyclic diene monomer, methyl methacrylate, maleic acid anhydride, or acrylonitrile may be mentioned.

The syndiotactic-vinyl aromatic polymers of the present invention may be block copolymers, random copolymers, or alternating copolymers.

The vinyl aromatic polymer having high level syndiotactic structure referred to in this invention generally includes polystyrene having syndiotacticity of higher than 75% or more, as determined by carbon-13 nuclear magnetic resonance. Preferably, the degree of syndiotacticity is higher than 85% racemic diad, or higher than 30%, or more preferably, higher than 50%, racemic pentad.

In addition, although there are no particular restrictions regarding the molecular weight of this syndiotactic-vinyl aromatic group polymer, preferably, the weight average molecular weight is greater than 10,000 and less than 1,000,000, and more preferably, greater than 50,000 and less than 800,000.

As for the other resins, various types may be mentioned, including, for instance, vinyl aromatic group polymers with atactic structures, vinyl aromatic group polymers with isotactic structures, and all polymers that are miscible. For example, polyphenylene ethers show good miscibility with the previous explained vinyl aromatic group polymers. Furthermore, the composition of these miscible resin components is preferably between 70 to 1 weight %, or more preferably, 50 to 2 weight %. When composition of miscible resin component exceeds 70 weight %, degradation on the heat resistance may occur, and is usually not desirable.

Polyesters and polycarbonates are also preferred polymers. It is not required that the selected polymer for a particular phase be a copolyester or copolycarbonate. Vinyl polymers and copolymers made from monomers such as vinyl naphthalenes, styrenes, ethylene, maleic anhydride, acrylates, and methacrylates may also be employed. Condensation polymers, other than polyesters and polycarbonates, can also be utilized. Suitable condensation polymers include polysulfones, polyamides, polyurethanes, polyamic acids, and polyimides. Naphthalene groups and halogens such as chlorine, bromine and iodine are useful in increasing the refractive index of the selected polymer to the desired level (1.59 to 1.69) if needed to substantially match the refractive index if PEN is the host. Acrylate groups and fluorine are particularly useful in decreasing the refractive index.

Minor amounts of comonomers may be substituted into the naphthalene dicarboxylic acid polyester so long as the large refractive index difference in the orientation direction(s) is not substantially compromised. A smaller index difference (and therefore decreased reflectivity) may be counterbalanced by advantages in any of the following: improved adhesion between the continuous and discontinuous phase, lowered temperature of extrusion, and better match of melt viscosities.

Preferably, the light directing film is oriented more in the machine direction (MD) than the transverse direction (TD). Samples displayed better optical performance if oriented in the MD rather than TD direction. Without wishing to be bound by theory, it is believed that different geometry inclusions are developed with an MD orientation than with a TD orientation and that these discontinuous phases have higher aspect ratios, making non-ideal end effects less important. The non-ideal end effect refers to the complex geometry/index of refraction relationship at the tip of each end of the elongated particles. The interior or non-end of the particles are thought to have a uniform geometry and refractive index that is thought to be desirable. Thus, the higher the percentage of the elongated particle that is uniform, the better the optical performance.

Preferably, the light directing polymeric film is stretched unconstrained, meaning that the grippers that hold the film at a fixed dimension perpendicular to the direction of stretch are not engaged and the film is allowed to relax or neckdown in that dimension. A noticeable improvement in performance is observed when the samples were stretched unconstrained.

Preferably, the three dimensional features on the light directing film are discrete individual optical elements of well defined shape for refracting the incident light distribution such that the distribution of light exiting the films is in a direction more normal to the surface of the films. These individual optical elements may be formed by depressions in or projections on the exit surface of the films, and include one or more sloping surfaces for refracting the incident light toward a direction normal to the exit surface. These sloping surfaces may for example include a combination of planar and curved surfaces that redirect the light within a desired viewing angle. Also, the curvature of the surfaces, or the ratio of the curved area to the planar area of the individual optical elements as well as the perimeter shapes of the curved and planar surfaces may be varied to tailor the light output distribution of the films, to customize the viewing angle of the display device used in conjunction with the films. In addition, the curvature of the surfaces, or the ratio of the curved area to the planar area of the individual optical elements may be varied to redirect more or less light that is traveling in a plane that would be parallel to the grooves of a prismatic or lenticular grooved film. Also the size and population of the individual optical elements, as well as the curvature of the surfaces of the individual optical elements may be chosen to produce a more or less diffuse output or to randomize the input light distribution from the light source to produce a softer more diffuse light output distribution while maintaining the output distribution within a specified angular region about the direction normal to the films.

The three dimensional features (example individual optical elements) on the exit surface of the films are preferably randomized in such a way as to eliminate any interference with the pixel spacing of a liquid crystal display. This randomization can include the size, shape, position, depth, orientation, angle or density of the optical elements. This eliminates the need for diffuser layers to defeat moiré and similar effects. Also, at least some of the individual optical elements may be arranged in groupings across the exit surface of the films, with at least some of the optical elements in each of the groupings having a different size or shape characteristic that collectively produce an average size or shape characteristic for each of the groupings that varies across the films to obtain average characteristic values beyond machining tolerances for any single optical element and to defeat moiré and interference effects with the pixel spacing of a liquid crystal display. In addition, at least some of the individual optical elements may be oriented at different angles relative to each other for customizing the ability of the films to reorient/redirect light along two different axes.

The angles that the light redirecting surfaces of the individual optical elements make with the light exit surface of the films may also be varied across the display area of a liquid crystal display to tailor the light redirecting function of the films to a light input distribution that is non-uniform across the surface of the light source.

The individual optical elements of the light redirecting films also desirably overlap each other, in a staggered, interlocked and/or intersecting configuration, creating an optical structure with excellent surface area coverage. Moreover, the individual optical elements may be arranged in groupings with some of the individual optical elements oriented along one axis and other individual optical elements oriented along another axis. Also, the orientation of the individual optical elements in each grouping may vary. Further, the size, shape, position and/or orientation of the individual optical elements of the light redirecting films may vary to account for variations in the distribution of light emitted by a light source.

The properties and pattern of the optical elements of light redirecting films may also be customized to optimize the light redirecting films for different types of light sources which emit different light distributions, for example, one pattern for single bulb laptops, another pattern for double bulb flat panel displays, and so on.

Further, light redirecting film systems are provided in which the orientation, size, position and/or shape of the individual optical elements of the light redirecting films are tailored to the light output distribution of a backlight or other light source to reorient or redirect more of the incident light from the backlight within a desired viewing angle. Also, the backlight may include individual optical deformities that collimate light along one axis and the light redirecting films may include individual optical elements that collimate light along another axis perpendicular to the one axis.

It is preferred that the light directing polymeric film transmits at least 60% of light of one polarization, more preferred 80% and most preferred 90% while reflecting at least 60%, more preferred 80% and most preferred 90%, of the light of the opposite polarization. This enables light of the polarization typically absorbed into a traditional absorptive polarizer (such as iodine stained PVA) to be reflected back. The light that reflected back can be scattered and change its polarization, bounce off the back reflector of the backlight assembly or bounce off another film and pass through the light directing film in the correct polarization for the first polarizer.

Preferably, the film scatters collimated light asymmetrically to an angle of view of at least 80 degrees in a first direction and less than 10 degrees in a second direction orthogonal to the first direction. The angle of view is the angle The difference in the indices of diffraction between the continuous and discontinuous phase material and the orientation of the elongated structures provides useful optical properties to the polymeric composition. The polymeric composition can anisotropically scatter light. This light can be transmitted through or reflected by the polymeric composition. The largest scattering angles occur in directions substantially perpendicular to the major axes of the elongated structures. The smallest scattering angles occur in directions substantially parallel to the major axes of the elongated structures. For example, in a polymeric composition having the major axes of the elongated structures oriented in the vertical direction, the largest scattering angles will be observed in the horizontal direction and the smallest scattering angles will be observed in the vertical direction. Thus, a film utilizing this polymeric composition and placed over a light source can have a substantially increased horizontal viewing angle due to the increased scattering angles as a result of the oriented elongated structures with little or no increase in the vertical viewing angle. This configuration can be particularly useful with displays and projections screens. Furthermore, because the film can spread light so anisotropically (to almost a narrow straight line) the film can used to spread a collimated source into a beam of light as would be useful for scanners and other optical reading devices.

The size and shape of the elongated structures will also influence the optical properties. For example, diffuse reflection will be obtained when the cross-sectional dimension (e.g., diameter) of the elongated structures is no more than about several times the wavelength of light incident on the polymeric composition. As the cross-sectional dimension of the elongated structures increases, the amount of specular reflection will typically increase. In addition, longer elongated structures typically have more light scattered in the preferential directions than do shorter elongated structures of the same material and cross-sectional dimension. Thus, long fibers will tend to result in larger amounts of diffusely scattered light perpendicular to the length of the fibers. Shorter rods of material will typically result in less preferential scattering in the perpendicular directions.

The three-dimensional shape and size of the elongated structures affect how the scattering light is distributed into spatial directions. For spherical particles, the distribution of the light scattering is symmetric around the optical axis, which is defined as the axis of incident light. If the particles are non-spherical, light scattering will generally be distributed asymmetrically around the optical axis. Typically, light scattering is spread more widely in the plane where the cross section of the particles is more curved. For particles with ellipsoidal cross section, light is spread more around the longer axis than around the shorter axis. The degree of asymmetry is dependent on the aspect ratio of the particles (how far the cross section is away from a circle). For fibers, light is preferentially scattered in the direction normal to the orientation of the fibers. In the direction parallel to the fiber orientation, the polymeric composition acts as an optical parallel plate. Therefore, little light will be scattered. The film resembles a uniaxial light diffuser. For the best effect, the fibers preferably have an aspect ratio of at least 50, 100, or even 1000 or more. For elongated particles with a smaller aspect ratio, the cross section of the particles is more likely to be ellipsoid. In this case, some of the light will be scattered into the direction parallel to the fiber orientation. Such fibers act as ellipsoid diffusers. Combining a polymeric composition with high aspect ratio fibers with a weak symmetric diffuser element containing spherical particles can also make an ellipsoid diffuser.

A layer of material which is substantially free of a discontinuous phase may be coextensively disposed on one or both major surfaces of the optical body, i.e., the extruded blend of the discontinuous phase and the continuous phase.

The composition of such a layer or layers, also called skin layers, may be chosen, for example, to protect the integrity of the discontinuous phase within the extruded blend, to add mechanical or physical properties to the final optical body or to add optical functionality to the final optical body. Suitable materials of choice may include the material of the continuous phase or the material of the discontinuous phase. Other materials with a melt viscosity similar to the extruded blend may also be useful.

A skin layer or layers may also add physical strength to the resulting composite or reduce problems during processing, such as, for example, reducing the tendency for the optical body to split during the orientation process. Skin layer materials which remain amorphous may tend to make optical bodies with a higher toughness, while skin layer materials which are semicrystalline may tend to make optical bodies with a higher tensile modulus. Other functional components such as antistatic additives, UV absorbers, dyes, antioxidants, and pigments, may be added to the skin layer, provided they do not substantially interfere with the desired optical properties of the resulting product.

Skin layers or coatings may also be added to impart or improve puncture and/or tear resistance in the resulting article. Thus, for example, in embodiments in which the outer layer of the optical body contains coPEN as the major phase, a skin layer of monolithic coPEN may be coextruded with the optical layers to impart good tear resistance to the resulting optical body. Factors to be considered in selecting a material for a tear resistant layer include percent elongation to break, Young's modulus, tear strength, adhesion to interior layers, percent transmittance and absorbance in an electromagnetic bandwidth of interest, optical clarity or haze, refractive indices as a function of frequency, texture and roughness, melt thermal stability, molecular weight distribution, melt rheology and coextrudability, miscibility and rate of inter-diffusion between materials in the skin and optical layers, viscoelastic response, relaxation and crystallization behavior under draw conditions, thermal stability at use temperatures, weatherability, ability to adhere to coatings and permeability to various gases and solvents. Puncture or tear resistant skin layers may be applied during the manufacturing process or later coated onto or laminated to the optical body. Adhering these layers to the optical body during the manufacturing process, such as by a coextrusion process, provides the advantage that the optical body is protected during the manufacturing process. In some embodiments, one or more puncture or tear resistant layers may be provided within the optical body, either alone or in combination with a puncture or tear resistant skin layer.

The skin layers may be applied to one or two sides of the extruded blend at some point during the extrusion process, i.e., before the extruded blend and skin layer(s) exit the extrusion die. This may be accomplished using conventional coextrusion technology, which may include using a three-layer coextrusion die. Lamination of skin layer(s) to a previously formed optical body of an extruded blend is also possible. Total skin layer thicknesses may range from about 2% to about 50% of the total blend/skin layer thickness.

A wide range of polymers are suitable for skin layers. Of the predominantly amorphous polymers, suitable examples include copolyesters based on one or more of terephthalic acid, 2,6-naphthalene dicarboxylic acid, isophthalic acid phthalic acid, or their alkyl ester counterparts, and alkylene diols, such as ethylene glycol. Examples of semicrystalline polymers suitable for use in skin layers include 2,6-polyethylene naphthalate, polyethylene terephthalate, and nylon materials. Skin layers that may be used to increase the toughness of the optical film include high elongation polyesters such as Ecdel® and PCTG 5445 (available commercially from Eastman Chemical Co., Rochester, N.Y.) and polycarbonates. Polyolefins, such as polypropylene and polyethylene, may also be used for this purpose, especially if they are made to adhere to the optical film with a compatibilizer.

Various functional layers or coatings may be added to the optical bodies of the present invention to alter-or improve their physical or chemical properties, particularly along the surface of the optical body. Such layers or coatings may include, for example, slip agents, low adhesion backside materials, conductive layers, antistatic coatings or films, barrier layers, flame retardants, UV stabilizers, abrasion resistant materials, optical coatings, or substrates designed to improve the mechanical integrity or strength of the optical body. Examples of some suitable layers or coatings are discussed in U.S. patent application Ser. No. 08/494,416.

The optical bodies used in connection with the present invention may be given good slip properties by treating them with low friction coatings or slip agents, such as polymer beads coated onto the surface. Alternately, the morphology of the surfaces of these materials may be modified, as through manipulation of extrusion conditions, to impart a slippery surface to the optical body; methods by which surface morphology may be so modified are described in U.S. Pat. No. 5,759,467.

The optical bodies used in connection with the present invention may also be provided with one or more conductive layers. Such conductive layers may comprise metals such as silver, gold, copper, aluminum, chromium, nickel, tin, and titanium, metal alloys such as silver alloys, stainless steel, and inconel, and semiconductor metal oxides such as doped and undoped tin oxides, zinc oxide, and indium tin oxide (ITO).

The optical bodies used in connection with the present invention may also be provided with antistatic coatings or films. Such coatings or films include, for example, V₂O₅ and salts of sulfonic acid polymers, carbon, polythiophine, or other conductive metal layers.

The optical bodies used in connection with the present invention may also be provided with abrasion-resistant or hard coatings, which will frequently be applied as a skin layer. These include acrylic hardcoats such as Acryloid A-11 and Paraloid K-120N, available from Rohm & Haas, Philadelphia, Pa.; urethane acrylates, such as those described in U.S. Pat. No. 4,249,011 and those available from Sartomer Corp., Westchester, Pa.; and urethane hardcoats obtained from the reaction of an aliphatic polyisocyanate (e.g., Desmodur N-3300, available from Miles, Inc., Pittsburgh, Pa.) with a polyester (e.g., Tone Polyol 0305, available from Union Carbide, Houston, Tex.).

The optical bodies used in connection with the present invention may further be laminated to rigid or semi-rigid substrates, such as those described in U.S. patent application Ser. No. 08/807,270 (filed on Feb. 28, 1997). The substrates chosen may provide structural rigidity, weatherability, thermal stability, easier handling, etc.

The optical bodies used in connection with the present invention may also be provided with shatter resistant films and coatings. Films and coatings suitable for this purpose are described, for example, in publications EP 592284 and EP 591055, and are available commercially from 3M Company, St. Paul, Minn.

Various optical layers, materials, and devices may also be applied to, or used in conjunction with, the optical bodies used in connection with the present invention for specific applications. These include, but are not limited to, magnetic or magneto-optic coatings or films; liquid crystal panels, such as those used in display panels and privacy windows; photographic emulsions; fabrics; prismatic films, such as linear Fresnel lenses; brightness enhancement films; holographic films or images; embossable films; anti-tamper films or coatings; IR transparent film for low emissivity applications; release films or release coated paper; and polarizers or mirrors.

If desired, one or more sheets of a continuous/discontinuous phase film made in accordance with the present invention may be used in combination with, or as a component in, a multilayered optical film to provide desirable optical properties. Such combinations could improve reflectivity for light of one or both polarizations. Alternatively, the combination could be used to specularly transmit light of one polarization and diffusely transmit light of the orthogonal polarization, transmitting both polarization orientations with low or minimal absorption. In such a construction, the individual sheets may be coextruded, laminated, or otherwise adhered together, or they may be spaced apart.

The optical bodies used in connection with the present invention may also include one or more anti-reflective layers or coatings, such as, for example, conventional vacuum coated dielectric metal oxide or metal/metal oxide optical films, silica sol gel coatings, and coated or coextruded antireflective layers such as those derived from low index fluoropolymers such as THV, an extrudable fluoropolymer available from 3M Company (St. Paul, Minn.). Such layers or coatings, which may or may not be polarization sensitive, serve to increase transmission and to reduce reflective glare, and may be imparted to the optical bodies used in connection with the present invention through appropriate surface treatment, such as coating or sputter etching. A particular example of an antireflective coating is described in more detail in Examples 132-133 of U.S. patent application Ser. No. 08/807,262.

In some embodiments of the optical bodies used in connection with the present invention, it is desired to maximize the transmission and/or minimize the specular reflection for certain polarizations of light. In these embodiments, the optical body may comprise two or more layers in which at least one layer comprises an anti-reflection system in close contact with a layer providing the continuous and discontinuous phases. Such an anti-reflection system acts to reduce the specular reflection of the incident light and to increase the amount of incident light that enters the portion of the body comprising the continuous and discontinuous layers. Such a function can be accomplished by a variety of means well known in the art. Examples are quarter wave anti-reflection layers, two or more layer anti-reflective body, graded index layers, and graded density layers. Such anti-reflection functions can also be used on the transmitted light side of the body to increase transmitted light if desired.

The optical bodies used in connection with the present invention may be protected from UV radiation through the use of UV stabilized films or coatings. Suitable UV stabilized films and coatings include those which incorporate benzotriazoles or hindered amine light stabilizers (HALS) such as Tinuvin® 292, both of which are available commercially from Ciba Geigy Corp., Hawthorne, N.Y. Other suitable UV stabilized films and coatings include those which contain benzophenones or diphenyl acrylates, available commercially from BASF Corp., Parsippany, N.J. Such films or coatings will be particularly important when the optical bodies of the present invention are used in outdoor applications or in luminaires where the source emits significant light in the UV region of the spectrum.

The optical bodies used in connection with the present invention may be subjected to various treatments which modify the surfaces of these materials, or any portion thereof, as by rendering them more conducive to subsequent treatments such as coating, dying, metallizing, or lamination. This may be accomplished through treatment with primers, such as PVDC, PMMA, epoxies, and aziridines, or through physical priming treatments such as corona, flame, plasma, flash lamp, sputter-etching, e-beam treatments, or amorphizing the surface layer to remove crystallinity, such as with a hot can.

Both visible and near IR dyes and pigments are contemplated for use in connection with the optical bodies of the present invention, and include, for example, optical brighteners such as dyes that absorb in the UV and fluoresce in the visible region of the color spectrum. Other additional layers that may be added to alter the appearance of the optical body include, for example, opacifying (black) layers, diffusing layers, holographic images or holographic diffusers, and metal layers. Each of these may be applied directly to one or both surfaces of the optical body, or may be a component of a second film or foil construction that is laminated to the optical body. Alternately, some components such as opacifying or diffusing agents, or colored pigments, may be included in an adhesive layer which is used to laminate the optical body to another surface.

The optical bodies used in connection with the present invention may also be provided with metal coatings. Thus, for example, a metallic layer may be applied directly to the optical film by pyrolysis, powder coating, vapor deposition, cathode sputtering, ion plating, and the like. Metal foils or rigid metal plates may also be laminated to the optical body, or separate polymeric films or glass or plastic sheets may be first metallized using the aforementioned techniques and then laminated to the optical bodies used in connection with the present invention.

Preferably, the substrate is a polymer with a light transmission of at least 85%. An 85% light transmission value allows backlit devices to improve battery life and increase screen brightness. The most preferred light transmission of the substrate is greater than 92%. A light transmission of 92% allows for transmission of the back light and maximizes the brightness of a liquid crystal device significant improving the image quality of a backlit device for outdoor use where the display must compete with natural sunlight. Preferably, the substrate is formed with the blend of immiscible polymers is formed. One example of this is co-extrusion. Forming the blend and the substrate at the same time allows for better adhesion between the two layers and support during the stretching operation for the immiscible polymer blend.

The substrate is preferably, a voided polymer. Microvoided substrates are preferred because the voids provide opacity without the use of TiO₂. They also provide cushioning during a printing process. Microvoided composite oriented sheets are conveniently manufactured by coextrusion of the core and surface layers, followed by biaxial orientation, whereby voids are formed around void-initiating material contained in the core layer. The voided polymer substrate can diffuse light in transmission or reflection. Such composite sheets are disclosed in, for example, U.S. Pat. Nos. 4,377,616; 4,758,462; and 4,632,869. The voided polymer substrate can be voided using void initiating particles or can be foamed.

Preferably, the substrate and/or the blend of immiscible polymers contains a dispersion of minute particles having a mean particle size less than 100 nanometers. The nanoparticles can change the index of refraction of the substrate without significantly affecting the scattering the substrate. Furthermore, the addition of nanoparticles to the substrate can increase printability and enhance the mechanical features of the substrate, such as hardness and glass transition temperature. In addition, when nanoparticles are added to the substrate, the substrate can be tailored to the index of refraction of the surface features so that there are no Fresnel loses at the interface between the substrate and the surface features.

The substrate preferably diffracts light. The substrate may be holographic or contain multiple thin layers. This can add holographic images to the optical element for an interesting look. It can also cause a mirror effect by diffracting most of the visible light. The optical element with a holographic substrate could be used in an LC display in a watch or clock and could be customized. The substrate may also contain a bland of immiscible polymers.

Dichroic dyes are a particularly useful additive for many of the applications to which the optical bodies and article manufactured from them are directed, due to their ability to absorb light of a particular polarization when they are molecularly aligned within the material. When used in a film or other material which predominantly scatters only one polarization of light, the dichroic dye causes the material to absorb one polarization of light more than another. Suitable dichroic dyes for use in the present invention include Congo Red (sodium diphenyl-bis-α-naphthylamine sulfonate), methylene blue, stilbene dye (Color Index (CI)=620), and 1,1′-diethyl-2,2′-cyanine chloride (CI=374 (orange) or CI=518 (blue)). The properties of these dyes, and methods of making them, are described in E. H. Land, Colloid Chemistry (1946). These dyes have noticeable dichroism in polyvinyl alcohol and a lesser dichroism in cellulose. A slight dichroism is observed with Congo Red in PEN. The properties of these dyes, and methods of making them, are discussed in the Kirk Othmer Encyclopedia of Chemical Technology, Vol. 8, pp. 652-661 (4th Ed. 1993), and in the references cited therein. When a dichroic dye is used in the optical bodies of the present invention, it may be incorporated into either the continuous or discontinuous phase.

Dichroic dyes in combination with certain polymer systems exhibit the ability to polarize light to varying degrees. Polyvinyl alcohol and certain dichroic dyes may be used to make films with the ability to polarize light. Other polymers, such as polyethylene terephthalate or polyamides, such as nylon-6, do not exhibit as strong an ability to polarize light when combined with a dichroic dye. The polyvinyl alcohol and dichroic dye combination is said to have a higher dichroism ratio than, for example, the same dye in other film forming polymer systems. A higher dichroism ratio indicates a higher ability to polarize light.

Adhesives may be used to laminate the optical bodies used in connection with the present invention to another body, film, surface, or substrate. Such adhesives include both optically clear and diffuse adhesives, as well as pressure sensitive and non-pressure sensitive adhesives. Pressure sensitive adhesives are normally tacky at room temperature and can be adhered to a surface by application of, at most, light finger pressure, while non-pressure sensitive adhesives include solvent, heat, or radiation activated adhesive systems. Examples of adhesives useful in the present invention include those based on general compositions of polyacrylate; polyvinyl ether; diene-containing rubbers such as natural rubber, polyisoprene, and polyisobutylene; polychloroprene; butyl rubber; butadiene-acrylonitrile polymers; thermoplastic elastomers; block copolymers such as styrene-isoprene and styrene-isoprene-styrene block copolymers, ethylene-propylene-diene polymers, and styrene-butadiene polymers; polyalphaolefins; amorphous polyolefins; silicone; ethylene-containing copolymers such as ethylene vinyl acetate, ethylacrylate, and ethylmethacrylate; polyurethanes; polyamides; polyesters; epoxies; polyvinylpyrrolidone and vinylpyrrolidone copolymers; and mixtures of the above.

Additionally, the adhesives can contain additives such as tackifiers, plasticizers, fillers, antioxidants, stabilizers, pigments, diffusing particles, curatives, and solvents. When a laminating adhesive is used to adhere an optical film of the present invention to another surface, the adhesive composition and thickness are preferably selected so as not to interfere with the optical properties of the optical film. For example, when laminating additional layers to an optical polarizer or mirror wherein a high degree of transmission is desired, the laminating adhesive should be optically clear in the wavelength region that the polarizer or mirror is designed to be transparent in.

Preferably, the three dimensional features comprise curved surfaces. Curved concave and convex polymer lenses have been shown to provide very efficient shaping of light and high transparency. The lenses can vary in dimensions or frequency to control the amount of diffusion achieved. A high aspect ratio lens would diffuse the light more than a flatter, lower aspect ratio lens.

The polymeric diffusion film has a textured surface on at least one side, in the form of a plurality of random microlenses, or lenslets. The term “lenslet” means a small lens, but for the purposes of the present discussion, the terms lens and lenslet may be taken to be the same. The lenslets overlap to form complex lenses. “Complex lenses” means a major lens having on the surface thereof multiple minor lenses. “Major lenses” mean larger lenslets in which the minor lenses are formed randomly on top of. “Minor lenses” mean lenses smaller than the major lenses that are formed on the major lens. The plurality of lenses of all different sizes and shapes are formed on top of one another to create a complex lens feature resembling a cauliflower. The lenslets and complex lenses formed by the lenslets can be concave into the transparent polymeric film or convex out of the transparent polymeric film. The term “concave” means curved like the surface of a sphere with the exterior surface of the sphere closest to the surface of the film. The term “convex” means curved like the surface of a sphere with the interior surface of the sphere closest to the surface of the film.

In another embodiment of the invention, the three dimensional features are preferably complex lenses. Complex lenses are lenses on top of other lenses. They have been shown to provide very efficient diffusion of light and high transparency, enabling an efficient diffuser that also allows for brighter displays. The amount of diffusion is easily altered by changing the complexity, geometry, size, or frequency of the complex lenses to achieve the desired diffusion.

The plurality of lenses of all different sizes and shapes are formed on top of one another to create a complex lens feature resembling a cauliflower. The lenslets and complex lenses formed by the lenslets can be concave into the transparent polymeric film or convex out of the light directing film.

One embodiment of the present invention could be likened to the moon's cratered surface. Asteroids that hit the moon form craters apart from other craters, that overlap a piece of another crater, that form within another crater, or that engulf another crater. As more craters are carved, the surface of the moon becomes a complexity of depressions like the complexity of lenses formed in the light directing film.

The complex lenses may differ in size, shape, off-set from optical axis, and focal length. The curvature, depth, size, spacing, materials of construction (which determines the basic refractive indices of the polymer film and the substrate), and positioning of the lenslets determine the degree of diffusion, and these parameters are established during manufacture according to the invention.

The result of using a diffusion film having lenses whose optical axes are off-set from the center of the respective lens results in dispersing light from the film in an asymmetric manner. It will be appreciated, however, that the lens surface may be formed so that the optical axis is off-set from the center of the lens in both the x and y directions.

Preferably, the concave or convex lenses have an average frequency in any direction of from 5 to 250 complex lenses/mm. When a film has an average of 285 complex lenses/mm, creates the width of the lenses approach the wavelength of light. The lenses will impart a color to the light passing through the lenses and add unwanted color to the transmitted and reflected light. Having less than 4 lenses per millimeter creates lenses that are too large and therefore diffuse the light less efficiently. Concave or convex lenses with an average frequency in any direction of between 22 and 66 complex lenses/mm are more preferred. It has been shown that an average frequency of between 22 and 66 complex lenses provide efficient light diffusion and can be efficiently manufactured utilizing cast coated polymer against a randomly patterned roll.

The three dimensional features have concave or convex lenses at an average width between 3 and 60 micrometers in the x and y direction. When lenses have sizes below 1 micrometer the lenses impart a color shift in the light passing through because the lenses dimensions are on the order of the wavelength of light and add unwanted color to the transmitted or reflected light. When the lenses have an average width in the x or y direction of more than 68 micrometers, the lenses is too large to diffuse the light efficiently. More preferred, the concave or convex lenses at an average width between 15 and 40 micrometers in the x and y direction. This size lenses has been shown to create the most efficient diffusion and a high level of transmission.

The concave or convex complex lenses comprising minor lenses wherein the width in the x and y direction of the smaller lenses is preferably between 2 and 20 micrometers. When minor lenses have sizes below 1 micrometer the lenses impart a color shift in the light passing through because the lenses dimensions are on the order of the wavelength of light and add unwanted color to the light. When the minor lenses have sizes above 25 micrometers, the diffusion efficiency is decreased because the complexity of the lenses is reduced. More preferred are the minor lenses having a width in the x and y direction between 3 and 8 micrometers. This range has been shown to create the most efficient diffusion.

The number of minor lenses per major lens is preferably from 2 to 60. When a major lens has one or no minor lenses, its complexity is reduced and therefore it does not diffuse as efficiently. When a major lens has more than 70 minor lens contained on it, the width of some of the minor lens approaches the wavelength of light and imparts a color to the light transmitted. Most preferred are from 5 to 18 minor lenses per major lens. This range has been shown to produce the most efficient diffusion.

Preferably, the concave or convex lenses are semi-spherical meaning that the surface of each lenslet is a sector of a sphere, but not necessarily a hemisphere. This provides excellent even diffusion over the x-y plane. The semi-spherical shaped lenses scatter the incident light uniformly, ideal for a display application where the display area needs to be diffused uniformly.

The surface of each lenslet is a locally spherical segment, which acts as a miniature lens to alter the ray path of energy passing through the lens. The shape of each lenslet is “semi-spherical” meaning that the surface of each lenslet is a sector of a sphere, but not necessarily a hemisphere. Its curved surface has a radius of curvature as measured relative to a first axis (x) parallel to the transparent polymeric film and a radius of curvature relative to second axis (y) parallel to the transparent polymeric film and orthogonal to the first axis (x). The lenses in an array film need not have equal dimensions in the x and y directions. The dimensions of the lenses, for example length in the x or y direction, are generally significantly smaller than a length or width of the film.

The three dimensional features are preferably a surface diffuser. A surface diffuser utilizes with its rough surface exposed to air, affording the largest possible difference in index of refraction between the material of the diffuser and the surrounding medium and, consequently, the largest angular spread for incident light and very efficient diffusion.

The three dimensional features comprising a surface microstructure are preferred. A surface microstructure is easily altered in design of the surface structures and altered in with heat and/or pressure to achieve a macro light shaping efficiency variation before the film is oriented. Microstructures can be tuned for different light shaping and spreading efficiencies and how much they spread light. Examples of microstructures are a simple or complex lenses, prisms, pyramids, and cubes. The shape, geometry, and size of the microstructures can be changed to accomplish the desired light shaping.

The light shaping elements can comprise any surface structure. The light shaping elements can form a brightness enhancement article that features a flexible, transparent base layer and two distinct surfaces, each having a topography designed to act in concert to perform the function of controlling the exit angles of light emitted from a back-lit display. The article may take several forms. The brightness enhancement film, or BEF, can be a linear array of prisms with pointed, blunted, or rounded tops. The BEF's primary job to increase the an-axis brightness from a backlight in a LCD. It achieves this by recycling light entering the film at very shallow angles to the film (this light would be otherwise wasted as it passes through the liquid crystal). The BEF can also be made up of individual optical elements that can be, for example, sections of a sphere, prisms, pyramids, and cubes. The optical elements can be random or ordered, and independent or overlapping. The sides can be sloped, curved, or straight or any combination of the three. The light shaping elements can also be retroreflective structures, typically used for road and construction signs or a Fresnel lens designed to collimate light.

The light directing polymeric film can also be used as part of a light guide to produce light of substantially one polarization. The light directing polymeric film can also be used as part of a light guide to produce collimated light of substantially one polarization when the light directing film has collimating features as the three dimensional surface features. The light directing film may be laminated onto another substrates for added thickness and stability.

Embodiments of the invention evidence light shaping capability through providing similar contouring of the optical features and the micro-regions

### EXAMPLE

In this example an immiscible polymer blend reflective polarizer was created by extruding a blend of polymers onto a patterned roll to create a film with the immiscible polymer blend in substantially only the surface features where the micro-regions conformed to the surface features. This example will show that when stretched, this film had enhanced reflective polarization and luminance enhancement properties. Unless otherwise indicated, percent composition refers to percent composition by weight.

Polarized total, diffuse, and specular light transmission and reflection were measured using a Perkin Elmer Lambda 19 ultraviolet/visible/near infrared spectrophotometer equipped with a Perkin Elmer Labsphere S900-1000 150 millimeter integrating sphere accessory and a Glan-Thompson cube polarizer. Parallel and perpendicular polarization transmission and reflection values were measured with the polarized light parallel or perpendicular, respectively, to the stretch direction of the film. Transmission and reflectance values are quoted at 500 nanometers.

The cast films were created by co-extruding a two layer film. The first layer contained polyethylene naphthalate (PEN) extruded approximately 75 micrometers thick. The second layer was a blend of 60% polyethylene naphthalate (PEN) as the continuous phase and 40% of syndiotactic polystyrene (sPS) as the discontinuous phase into a cast film or sheet about 200 micrometers thick using conventional extrusion and casting techniques.

For the control example, the co-extruded two layer film was cast between to smooth rolls creating a substantially smooth cast film. For the example of the invention, the co-extruded film was cast between a smooth roller and a patterned roller. The patterned roller had surface features in the form of a linear array of triangular prisms. The prisms had a prism angle of 90 degrees and a pitch of 80 micrometers. The film was cast such that the layer of the co-extruded film containing the PEN and sPS was formed into the prism surface features. The blend of PEN and sPS was substantially only in the prism features and not in the bulk of the film. The micro-regions were determined to be substantially only in the surface features and did conform to the geometry of the surface features. These prism surface features are typically used to collimate the backlight of a liquid crystal display. Its performance is measured in gain (luminance of the film with the backlight on-axis divided by luminance of backlight alone on-axis). The prisms serve to collimate the light coming from the backlight and to reflect back (using total internal reflection) light incident on the film at high angles. Gain is measured as the % increase in brightness of the backlight with the film compared to without the film at the normal to the film and backlight surface. The backlight used was a standard backlight for a PDA with 2 cold fluorescent tubes on either side of the backlight parallel to each other.

Stretching of the control and invention samples was provided using either conventional orientation equipment used for making polyester film or a laboratory batch orienter. The laboratory batch orienter used was designed to use a small piece of cast material (7.5 cm by 7.5 cm) cut from the extruded cast web and held by a square array of 24 grippers (6 on each side). The orientation temperature of the sample was controlled a hot air blower and, in the unconstrained mode (U), grippers that hold the film at a fixed dimension perpendicular to the direction of stretch are not engaged and the film is allowed to relax or neckdown in that dimension.

The cast films of the example were oriented in the machine direction (MD). The stretching was accomplished at about 100 millimeters per second to 3 times its original length with a stretching temperature of about 150 degrees Celsius in both constrained and unconstrained modes.

The control and example of the invention were created with the same compositions, thickness, and stretched the same, the only difference being that the example of the invention had the immiscible polymer blend substantially only in the linear array of prism surface features with the micro-regions conforming to the geometry of the surface features. These surface features, filled with the immiscible polymer blend, increase the efficiency of polarization and light shaping.

| Percentages Measured | Example-Stretched | Control-Stretched |
|---|---|---|
| at 500 nm | Unconstrained | Unconstrained |
| Perpendicular | | |
| Total transmission | 82.73 | 75.56 |
| Total Reflection | 24.29 | 27.69 |
| Parallel | | |
| Total transmission | 19.77 | 24.01 |
| Total Reflection | 79.46 | 74.14 |
| Gain | 1.15 | 1.03 |

Perpendicular and parallel refer to the two polarizations of light, typically referred to as the p and s polarizations. Perpendicular refers to light of the polarization that is desired to pass through the polarizer. For the perpendicular measurements, it is desirable to have as much light pass through the sample (total transmission) and as little of the light reflected (total reflection). The light reflected could have been used by the liquid crystal but is reflected back towards the back of the device and recycled. Parallel refers to the light of the polarization that would be absorbed by an absorptive polarizer and cannot be used by the liquid crystals. It is desirable to reflect back as much of the parallel polarization and transmit as little of the parallel polarization as possible. The transmitted parallel polarization light is absorbed and lost by the absorptive polarizer. A perfect reflective polarizer would transmit 100% of the perpendicular polarization light and reflect 100% of the parallel polarization light. The reflected portions of the perpendicular and parallel polarizations reflect off of the reflector in the back of the display, are depolarized, and reflected back towards the reflective polarizer again.

Comparing the example of the invention with the control sample, for the desired perpendicular polarization of light the example transmitted 82.7% and reflected 24.3% of the light whereas the control only transmitted 75.6% and reflected back 27.7% of the light. The example let more of the preferred light through the sample and reflected back less of the desired polarization of light. This means that the light of the polarization state used by the liquid crystals (perpendicular) was more efficiently used by the example of the invention.

For the parallel polarization (reflected 100% by the perfect reflective polarizer), the example of the invention reflected back 79.5% to be recycled, while the control only reflected 74.1% of the light. The example let 19.8% of the light transmit through the film in the parallel polarization and the control let 24.0% of the light transmit. This light is then absorbed and lost by the absorptive polarizer.

The linear prism array filled with immiscible polymer reflective polarizer material of the example also increases the gain compared to a reflective polarizer that does not contain immiscible polymers with conforming micro-regions in surface features. The gain of the example was 1.15 versus the control example's gain of 1.03. The gain can be tailored by varying the geometry of the surface features filled with the immiscible polymer blend. Higher gain means more brightness on-axis to the display, which can create a brighter display or increase the battery life of a display. The gain also is affected by how the surface features change when they are stretched. For an optimized reflective polarizer/luminance enhancing collimating film, one would have to design the desired resultant surface features and back calculate what the starting surface feature geometry would be.

Because the micro-regions of the immiscible polymer blend conform to the surface feature (a linear prism array in this example) the light shaping efficiency of the film is increased. Furthermore, because light is being shaped and polarized at the same time, through the curvature of the micro-regions and the surface geometry, the film gains efficiency in light shaping.

Because the surface features are integral to the film and not coated on as an additional layer, there is not change in index of refraction between the surface features and the immiscible polar blend, meaning that there is no loss of efficiency in the film due to index of refraction mismatch. This makes the film more efficient over a film where surface features of a different index of refraction than the base are coated on a base, or two separate films (one for reflective polarization and one for collimating). Having an a film with integral surface features is also preferable because the film is more durable compared to a two layer structure that can delaminate under stress and handling causing the of the surface features to separate from the substrate.

Furthermore, the reflective polarizer with surface features can be created in one processing step, saving time and money. If the film was to be embossed after stretching, much more heat and pressure would be need to emboss the pattern because the film was already strain hardened. So much heat and pressure would have to be used that it might affect the optical properties of the film by changing the immiscible polymer blend or changing the birefringence of the film. It is also beneficial to have the immiscible polymer blend substantially only in the surface features because less material is used and the light is both polarized and shaped at the same time rather than sequentially.

While this example was primarily directed toward the use of thermoplastic light diffusion materials for LC devices and at prism shaped surface features, the materials of the invention have value in other diffusion applications such as back light display, imaging elements containing a diffusion layer, a diffuser for specular home lighting and privacy screens, image capture diffusion lenses and greenhouse light diffusion. The examples includes various polymer pairs, various fractions of continuous and disperse phases and other additives or process changes as discussed below.

The entire contents of the patents and other publications referred to in this specification are incorporated herein by reference.

### Parts List

1. A light directing polymeric film with a linear array of pyramidal structures, where the linear array is parallel to the discontinuous phase orientation.

2. Substrate

6. Continuous phase first thermoplastic polymeric material

8. Discontinuous phase thermoplastic polymeric material

10. Linear array of prisms

16. A light directing polymeric film with a linear array of pyramidal structures, where the linear array is perpendicular to the discontinuous phase orientation.

18. Substrate

20. Linear array of prisms

22. Continuous phase first thermoplastic polymeric material

24. Discontinuous phase thermoplastic polymeric material

30. A light directing polymeric film with three dimensional features that are individual optical elements filled with the immiscible polymer blend.

32. Substrate

34. Individual optical element

36. Continuous phase first thermoplastic polymeric material

38. Discontinuous phase thermoplastic polymeric material

What is claimed is:

1. A light directing polymeric film bearing on a surface thereof three-dimensional features having an Ra of at least 3 micrometers, the features containing a polymer dispersion comprising a continuous phase first thermoplastic polymeric material and a discontinuous phase second thermoplastic polymeric material that is immiscible with the first polymeric material and is dispersed in elongated micro-regions.

2. The light direction polymeric film of claim 1 wherein the elongated micro-regions are spherical, elliptical, or fibrillar.

3. The light directing polymeric film of claim 1 wherein the elongated micro-regions conform to the geometry of the three dimensional features.

4. The light directing polymeric film of claim 1 wherein the elongated micro-regions and the longitudinal direction of the three-dimensional features are substantially parallel.

5. The light directing polymeric film of claim 1 wherein the micro-regions have an aspect ratio of at least 100.

6. The light directing polymeric film of claim 1 that further comprises a third thermoplastic polymeric material phase.

7. The light directing film of claim 1 where the second thermoplastic polymeric material comprises 15 to 30% by volume relative to the first thermoplastic polymeric material.

8. The light directing polymeric film of claim 1 wherein the first and second thermoplastic polymeric materials have indices of refraction that differ by less than 0.05 along a first axis and by more than 0.05 along a second axis orthogonal to the first axis.

9. The light directing polymeric film of claim 1 wherein the film has a gain of at least 1.2 at the normal to the film when illuminated by a standard LCD backlight.

10. The light directing polymeric film of claim 1 wherein the three dimensional features are substantially void-free.

11. The light directing polymeric film of claim 1 wherein the polymeric film is voided.

12. The light directing polymeric film of claim 1 wherein the polymeric film comprises minute layered particles.

13. The light directing film of claim 1 wherein the composition of the first and second thermoplastic polymers varies across the film.

14. The light directing film of claim 1 wherein the three dimensional features are on both sides of the light directing polymeric film.

15. The light directing film of claim 1 wherein the three dimensional features having an Ra of at least 10 micrometers.

16. The light directing film of claim 1 wherein the three dimensional features have an aspect ratio of from 0.1 to 7.

17. The light directing film of claim 1 wherein the first thermoplastic polymer comprises a polyethylene napthalate.

18. The light directing film of claim 1 wherein the second thermoplastic polymer comprises a polystryene.

19. The light directing film of claim 1 wherein the second thermoplastic polymer comprises poly(methyl)methacrylate.

20. The light directing film of claim 1 wherein the first or second thermoplastic polymer is polycarbonate.

21. The light directing film of claim 1 wherein the first or second thermoplastic polymer is polyethylene.

22. The light directing polymeric film of claim 1 wherein the light directing film is oriented in the machine direction more than the transverse direction.

23. The light directing polymeric film of claim 1 wherein the light directing film is oriented unconstrained.

24. The light directing polymeric film of claim 1 wherein the three dimensional features are individual optical elements.

25. The light directing polymeric film of claim 1 wherein the three dimensional features are individual optical elements with one curved side and one flat side.

26. The light directing polymeric film of claim 1 wherein the three dimensional features are random.

27. The light directing polymeric film of claim 1 wherein the three dimensional features are lenticular in shape.

28. The light directing polymeric film of claim 1 wherein the film transmits at least 60% of one polarization and reflects at least 60% of the opposite polarization.

29. The light directing polymeric film of claim 1 wherein the film scatters collimated light asymmetrically to an angle of view of at least 80 degrees in a first direction and less than 10 degrees in a second direction orthogonal to the first direction.

30. The light directing polymeric film of claim 1 wherein the three dimensional features comprise nanoparticles.

31. The light directing polymeric film of claim 1 wherein the light directing polymeric film further comprises a substrate.

32. The light directing polymeric film of claim 1 wherein the continuous phase thermoplastic first polymeric material and the discontinuous phase second thermoplastic polymeric material are located substantially only in the three-dimensional features.

33. A process for forming the layer of claim 1 comprising extruding a melt of a dispersion containing a continuous phase thermoplastic first polymeric material and a discontinuous phase second thermoplastic polymeric material into a nip between a patterned roller and a pressure roller, cooling the melt to solid state, heating the solid film and orienting the film and features in at least one direction.

34. The process of claim 33 in which the pressure roll has a pattern.

35. The process of claim 33 in which the stretching is unconstrained.

36. The process of claim 33 in which the optical features are dimensionally modified by at least 5% by the application of heat after the step of cooling the melt.
